(19) United States
(12) Patent Application Publication
(10) Pub. No.: US 2024/0369310 A1
(43) Pub. Date: Nov. 7, 2024

(54) A THERMAL ENERGY STORAGE SYSTEM

(71) Applicant: ENERGYINTEL SERVICES LTD, Nicosia (CY)

(72) Inventor: Daniel Persson, Amal (SE)

(73) Assignee: ENERGYINTEL SERVICES LTD, Nicosia (CY)

(21) Appl. No.: 18/576,488

(22) PCT Filed: Jun. 14, 2022
(86) PCT No.: PCT/SE2022/050586

§ 371 Date: Jan. 4, 2024

(30) Foreign Application Priority Data
Jul. 8, 2021 (SE) 2150912-0

(51) Int. Cl. F28D 20/02; F28D 20/00

(52) U.S. Cl. CPC F28D 20/021; F28D 2020/0069

(57) ABSTRACT

A thermal energy storage system is provided that includes a container for containing a phase change material, a jacket connected to the exterior of the container. A compartment is formed between the jacket and the container, the jacket having an inlet for receiving a heat transfer fluid into the compartment and an outlet for discharging heat transfer fluid from the compartment. Thermal energy is transferred from the heat transfer fluid present in the compartment to the phase change material, and a flow guide provided in the compartment for guiding and distributing the heat transfer fluid that enters through the inlet. At least one side of the flow guide is welded to the jacket. The flow guide includes a concealing portion which extends from the at least one side. The concealing portion extends across the inlet and is spaced apart from the inlet.

### TECHNICAL FIELD

The present disclosure relates to a thermal energy storage system. In particular, it relates to a thermal energy storage system in which thermal energy is transferred between a heat transfer fluid and a phase change material.

### BACKGROUND ART

A thermal energy storage system may be used for converting thermal energy to electricity. A phase change material may be heated and liquefied in a container. The phase change, from solid state to liquid state, results in a large energy recovery. The temperature at which the phase change material is liquefied may, e.g. be just under 600° C. Examples of suitable phase change materials are different aluminium alloys.

A heat transfer fluid may be used to heat the phase change material. By passing the heat transfer fluid along the container a thermal energy transfer between the heat transfer fluid and the phase change material occurs. An example of a heat transfer fluid may be sodium (Na), which is in liquid state at a temperature above 98° C. The heat transfer fluid may suitably be provided in a closed flow circuit in which the heat transfer fluid is pumped to via a heating device to a compartment at the container where the thermal energy transfer takes place. Such a compartment may be formed by a jacket connected to the exterior of the container.

A problem that may occur is that the heat transfer fluid is not adequately distributed within the compartment, whereby the thermal energy transfer will not be satisfactory enough. Depending on the flow distribution, the heat transfer fluid may exit the compartment with different temperatures, which therefore affects the power output from the heating device as well as the life span of the components in the flow circuit.

### SUMMARY OF THE INVENTION

An object of the present disclosure is to provide a thermal energy storage system which at least partly alleviates the drawbacks of the prior art. This and other objects, which will become apparent in the following discussion, are achieved by a thermal energy storage system according to the accompanying claim 1. Exemplary embodiments are presented in the dependent claims.

The present inventive concept is based on the realization that by blocking the natural flow direction of the heat transfer fluid just after entering the compartment, a better control of the flow distribution is achievable. In particular, the inventors have realized that by providing a flow guide in the form of an inlet cover, which is just slightly separated from the inlet, a good flow control is obtainable. The inventors have realized that such a covering relationship between the flow guide and the inlet is superior to just having a guiding rim or a guiding ridge (the heat transfer fluid may, for example, pass over such a guiding rim or guiding ridge).

According to an aspect of the present disclosure, there is provided a thermal energy storage system, comprising:
a container for containing a phase change material,
a jacket connected to the exterior of the container, wherein a compartment is formed between the jacket and a wall portion of the container, the jacket having an inlet for receiving a heat transfer fluid into said compartment and an outlet for discharging heat transfer fluid from said compartment, wherein thermal energy is transferred from the heat transfer fluid present in said compartment, via the wall portion of the container, to the phase change material, and
a flow guide provided in said compartment for guiding and distributing the heat transfer fluid that enters through said inlet, wherein at least one side of the flow guide is welded to the jacket, wherein the flow guide comprises a concealing portion which extends from said at least one side, wherein the concealing portion extends across said inlet and is spaced apart from said inlet.

By having a flow guide which has a side welded to the jacket and a concealing portion extending across the inlet, it is possible to obtain multi-dimensional delimitation and control of the heat transfer fluid that has entered the compartment. In simple terms, one can regard the flow guide as presenting a sidewall and a roof for the flowing heat transfer fluid (the sidewall extending from the jacket floor and the roof suitably being substantially parallel with the jacket floor). The flow guide enables the provision of right conditions for an even flow distribution in the jacket, resulting in a low heat flux (good heat exchange) when the heat transfer fluid exits the jacket, thereby obtaining a high performance flow circuit.

It should be understood that different jackets may be dimensioned and configured differently, such as having different curvatures, radii, etc. Thus, dimensions and configuration of the flow guide is suitably adapted to the jacket with which it will be used. For instance, the extension and curvature of the side welded to the jacket may be appropriately dimensioned, as well as the area of the concealing portion, without departing from the general idea of having multidimensional delimitations/guiding.

Although the background section of the present disclosure specifically discussed sodium, it should be understood that the present general inventive concept is applicable to any suitable heat transfer fluid (HTF), and is thus by no means limited to sodium. Similarly, the phase change material (PCM) does not necessarily have to be an aluminium alloy; the inventive concept being applicable also in connection to other phase change materials.

The jacket connected to the exterior of the container may suitably be connected to the bottom of the container, thus said compartment being formed underneath the container. The jacket may also be referred to as a charging jacket since the PCM turns into liquid phase when subjected to the heat from the HTF in the jacket. Thus, the thermal energy storage system is charged with energy. During energy discharge, heat may be transferred from the PCM through another HTF-circuit (whereby the PCM will shift back to solid phase) to energize a device. For instance, the heat from said other HTF-circuit may be used to heat a working gas to run a Stirling engine. It should be understood that the thermal energy storage system, may be used in other implementations as well where it is desired to store thermal energy.

According to at least one exemplary embodiment, said flow guide is formed as a box having a first opening area for receiving the heat transfer fluid from said inlet and at least one second opening area through which the heat transfer fluid exits the flow guide and becomes distributed in the compartment. This too provides good flow control. The opening areas may suitably be dimensioned according to the particular jacket to which the flow guide is mounted, and may suitably be arranged to face in an appropriate direction according to the flow pattern that is desired to obtain in the compartment formed by said jacket. This is at least partly reflected in the following exemplary embodiment.

According to at least one exemplary embodiment, said at least one second opening area faces in a circumferential direction of the jacket. Thus, the flow may be prevented from exiting the flow guide in the radial and/or the axial direction, and be forced to exit in a circumferential direction whereby a circular flow pattern may be obtained which covers substantially the entire floor of the jacket. Hereby, an even distribution is obtainable, resulting in a good thermal energy transfer to the PCM.

According to at least one exemplary embodiment, said at least one second opening area is provided with one or more tabs forming local obstructions to the flow in order to spread the heat transfer fluid exiting the flow guide. The tabs build up pressure to create a suitable flow pattern. Furthermore, different flow patterns may be created by changing the tab pattern in the second opening area.

According to at least one exemplary embodiment, the flow guide is welded to the jacket so that a continuous weld seem portion extends substantially in the radial direction of the jacket, and another continuous weld seem portion extends substantially in the circumferential direction of the jacket. This further benefits the provision of a good flow pattern.

Generally, all terms used in the claims are to be interpreted according to their ordinary meaning in the technical field, unless explicitly defined otherwise herein. All references to “a/an/the element, device, component, means, etc.” are to be interpreted openly as referring to at least one instance of the element, device, component, means, etc., unless explicitly stated otherwise. Further features and advantages of the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

FIG. 1 illustrates a thermal energy storage system according to at least one exemplary embodiment of the present disclosure.

FIGS. 2-6 illustrate different detailed views of the system of FIG. 1.

FIG. 7 illustrates a flow pattern obtainable by implementing the general inventive concept of the present disclosure.

### DETAILED DESCRIPTION

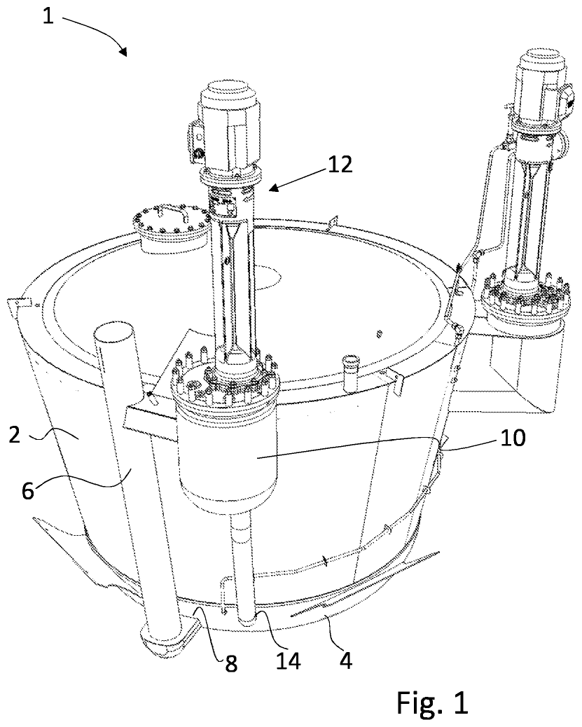

FIG. 1 illustrates a thermal energy storage system 1 according to at least one exemplary embodiment. The thermal energy storage system 1 comprises a container 2 for containing a phase change material, such as an aluminium alloy. The container 2 may have a relatively large size. A jacket 4 is connected to the exterior of the container 2, wherein a compartment (not visible in FIG. 1) is formed between the jacket 4 and a wall portion of the container 2. As illustrated in FIG. 1 the jacket 4 is suitably located at the bottom of the container 2, and may thus form the compartment together with a bottom wall portion of the container 2.

The thermal energy storage system 1 further comprises a heating chamber 6, which comprises a heating device. The heating chamber 6 is in fluid communication with an inlet 8 of the jacket 4. The thermal energy storage system 1 further comprises another container or vessel 10 and a pump arrangement 12 extending into the vessel 10. The vessel 10 may have a relatively small size. The vessel 10 is configured to contain a heat transfer fluid, such as liquid sodium. The pump arrangement 12 is configured to pump the heat transfer fluid from the vessel 10, via the heating chamber 6, to the compartment formed between the jacket 4 and the wall portion of the container 2. When passing through the heating chamber 6 the heat transfer fluid will become heated by the heating device. Thermal energy is transferred between the heat transfer fluid located in said compartment and the phase change material held in the container 2. More specifically, thermal energy is transferred from the heat transfer fluid to the phase change material via said wall portion of the container 2.

The jacket 4 has an outlet 14, from which heat transfer fluid, is pumped back into the second container 8. Thus, the pump arrangement 12 moves the heat transfer fluid in a closed circuit.

Because of the transfer of heat energy, the phase change material will melt and turn into liquid phase. This phase change charges the system 1 with energy, which may be discharged at a later point in time. The energy may be discharged by making use of another heat transfer fluid circuit to take up the thermal energy from the phase change material (which then shifts back to solid form). The discharge of energy and the various possible implementations of the discharged energy do not form part of the general inventive concept as such. However, it should be understood that the thermal energy storage system 1 of the present invention may be used in any suitable implementation as will be appreciated by the person skilled in the art. One such example is to energize a sterling motor.

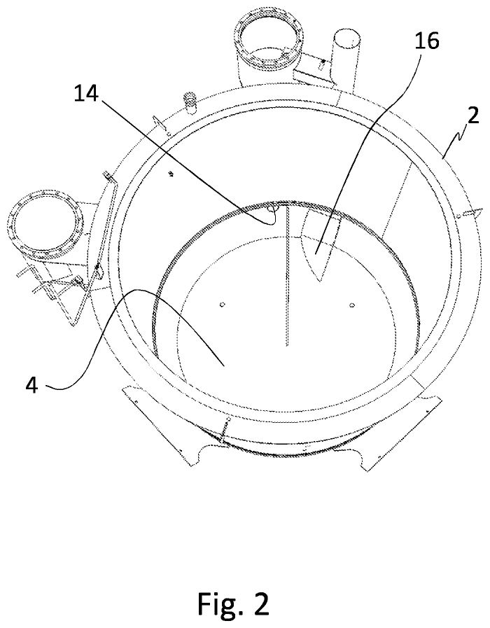

FIG. 2 is a view from above showing only a few details of the thermal energy storage system 1 of FIG. 1. More specifically, the container 2 is shown without its bottom wall portion, which has been removed to make the interior of the jacket 4 visible. As can be appreciated form FIG. 2, the jacket 4 may suitably have a slight dome-shape, which may be advantageous from a strength perspective. A flow guide 16 is welded to the inside of the jacket 4. Thus, the flow guide 16 is located in the compartment defined by the jacket 4 and the (in FIG. 2 removed) bottom wall portion of the container 2. The flow guide 16 is provided for guiding and distributing the heat transfer fluid that enters through the inlet of the jacket 4. The inlet is not visible in FIG. 2 because the flow guide 16 conceals the inlet. Thus, in FIG. 2 the inlet is located behind the flow guide 16. The outlet 14, however, is visible in FIG. 2.

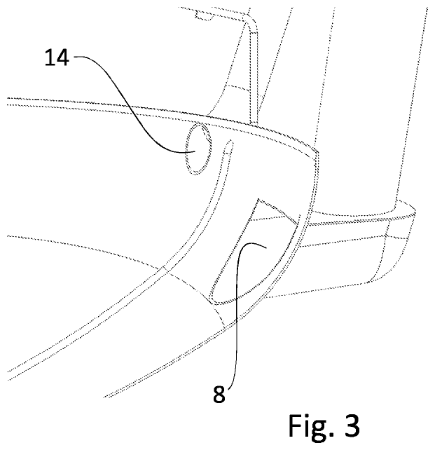

The inlet 8 is illustrated in a close-up view in FIG. 3. In other words, in the detailed view of FIG. 3 the flow guide has been removed. FIG. 3 also clearly shows the outlet 14.

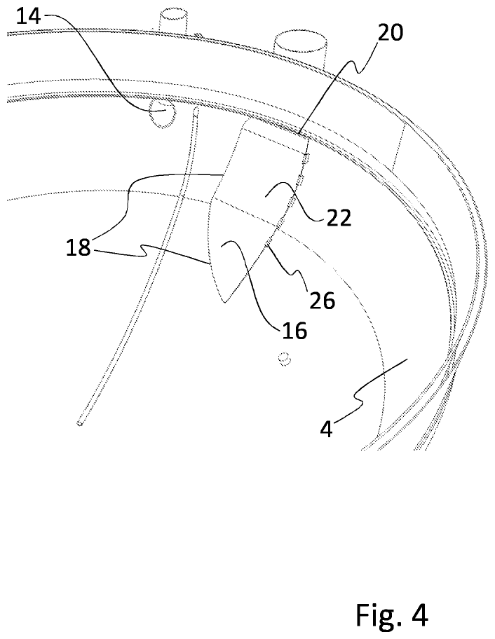

FIG. 4 is a close-up view in which the flow guide 16 is in place. At least one side of the flow guide 16 is welded to the jacket 4. In this illustrated exemplary embodiment, two sides are welded, namely a first side 18 running substantially radially in along the jacket, and a second side 20 running substantially in the circumferential direction. As can be seen in FIG. 4, the first side 18, may suitably have an angled or curved portion nearest the centre of the jacket 4. Thus, a portion of the first side 18 may deviate from the radial direction for improved guiding. The welded first side 18 is in this illustration located left of the inlet and the welded second side 20 is located above the inlet. The flow guide 16 is configured to provide a clockwise flow in this exemplary embodiment, since the outlet 14 is located adjacent the flow guide 16 seen in the counter-clockwise direction. In other exemplary embodiments, the location of the inlet and outlet may be the reverse, and thus the heat transfer fluid may instead be guided in the counter-clockwise direction. In a general sense, the inlet and outlet should suitably be located close to each other, and the flow should be guided from the inlet in a direction away from the outlet in order to allow the heat transfer fluid to cover a larger area before reaching the outlet.

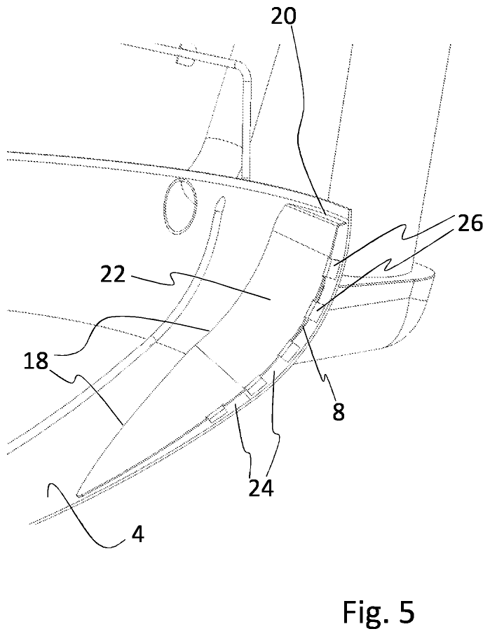

The interface between the jacket 4 and the first and second sides 18, 20 may suitably be achieved by respective continuous weld seem portions (extending radially and circumferentially, and in the illustrated example also slightly curved at centremost end of the first side 18). The flow guide 16 comprises a concealing portion 22 which extends from said at least one side, or as in the illustrated exemplary embodiment, from both the first side 18 and the second side 20. The concealing portion 22 extends from said sides 18, 20 across the inlet of the jacket 4, and is furthermore spaced from the inlet. This can be better seen in FIG. 5.

Thus, with reference to FIG. 5 it can be seen that the concealing portion 22 is located at a slight distance from the floor of the jacket 4 in which the inlet 8 is provided. By having welded sides 18, 20 connected the floor of the jacket 4, but the concealing portion 22 spaced apart, the flow guide is formed as a box. Thus, the welded sides 18, 20 also have the function of providing a distance between the inlet 8 and the concealing portion 22. As seen in FIG. 5 the flow guide, being in the form of a box has a first opening area (i.e. opposite to the concealing portion 22) for receiving the heat transfer fluid from the inlet 8 and at least one second opening area 24 through which the heat transfer fluid exits the flow guide and becomes distributed in the compartment.

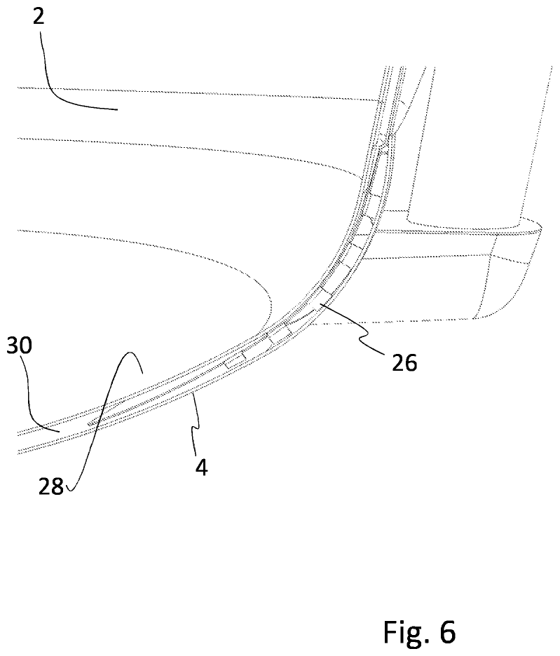

As can be further seen in FIG. 5 the at least one second opening area 24 may suitably face in a circumferential direction of the jacket 4. As illustrated, the at least one second opening area 24 may be provided with one or more tabs 26 forming local obstructions to the flow in order to spread the heat transfer fluid exiting the flow guide. As will be understood, the tabs 26 may also form a distance-creating part of the box-shaped flow guide to create a distance between the concealing portion 22 and the inlet 8. The tabs 26 are also visible in FIGS. 4 and 6.

FIG. 6 illustrates a detailed cross-sectional view in which the bottom wall portion 28 of the container 2 is visible. Thus, in this illustration the compartment 30 defined between the bottom wall portion 28 of the container 2 and the jacket 4 is clearly visible.

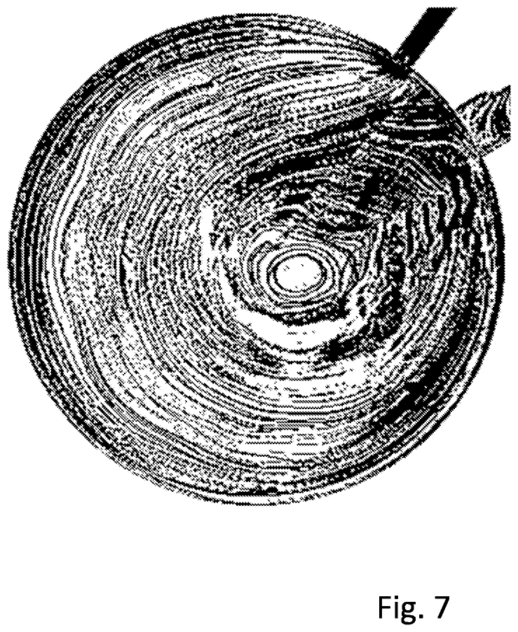

As will be appreciated from the above illustrations and explanations, the flow guide provides both a roof (by means of the concealing portion) and side walls whereby a good flow control is obtainable for the heat transfer fluid coming through the inlet into the compartment 30. The herein illustrated flow guide provides for a good distribution of the heat transfer fluid in the compartment. As can be seen in the illustration in FIG. 7, which shows the flow pattern, the heat transfer fluid will cover substantially the entire surface of the jacket, i.e. substantially the entire compartment defined by the jacket and the bottom wall portion of the container.

1. A thermal energy storage system (1), comprising:
a container (2) for containing a phase change material,
a jacket (4) connected to an exterior of the container, wherein a compartment (30) is formed between the jacket (4) and a wall portion (28) of the container, the jacket having an inlet (8) for receiving a heat transfer fluid into said compartment and an outlet (14) for discharging heat transfer fluid from said compartment, wherein thermal energy is transferred from the heat transfer fluid present in said compartment, via the wall portion of the container, to the phase change material, and
a flow guide (16) provided in said compartment for guiding and distributing the heat transfer fluid that enters through said inlet, wherein at least one side (18, 20) of the flow guide is welded to the jacket, wherein the flow guide comprises a concealing portion (22) which extends from said at least one side, wherein the concealing portion extends across said inlet and is spaced apart from said inlet.

2. The thermal energy storage system (1) according to claim 1, wherein said flow guide (16) is formed as a box having a first opening area for receiving the heat transfer fluid from said inlet (8) and at least one second opening area (24) through which the heat transfer fluid exits the flow guide and becomes distributed in the compartment (30).

3. The thermal energy storage system (1) according to claim 2, wherein said at least one second opening area (24) faces in a circumferential direction of the jacket (4).

4. The thermal energy storage system (1) according to claim 2, wherein said at least one second opening area (24) is provided with one or more tabs (26) forming local obstructions to the flow in order to spread the heat transfer fluid exiting the flow guide (16).

5. The thermal energy storage system (1) according to claim 1, wherein the flow guide (16) is welded to the jacket so that a continuous weld seem portion extends substantially in the radial direction of the jacket (4) and another continuous weld seem portion extends substantially in the circumferential direction of the jacket.

6. The thermal energy storage system (1) according to claim 3, wherein said at least one second opening area (24) is provided with one or more tabs (26) forming local obstructions to the flow in order to spread the heat transfer fluid exiting the flow guide (16).
